(19) United States
(12) Patent Application Publication
(10) Pub. No.: US 2025/0020461 A1
(43) Pub. Date: Jan. 16, 2025

(54) WEIGHING APPARATUS AND WEIGHING METHOD USING THE SAME WEIGHING APPARATUS

(71) Applicant: A&D Company, Limited, Tokyo (JP)

(72) Inventors: Hiroaki TATENO, Kitamoto-shi (JP); Tomoyuki ISHIMORI, Kitamoto-shi (JP); Yoshikazu NAGANE, Kitamoto-shi (JP)

(73) Assignee: A&D Company, Limited, Tokyo (JP)

(21) Appl. No.: 18/762,204

(22) Filed: Jul. 2, 2024

(30) Foreign Application Priority Data
Jul. 14, 2023 (JP) 2023-115976

(51) Int. Cl. G01C 9/06; G01P 15/18

(52) U.S. Cl. CPC G01C 9/06; G01P 15/18; G01C 2009/066

(57) ABSTRACT

A weighing apparatus includes a level gauge, a weight sensor, a accelerometer configured to detect acceleration changes of two axes of x, y on a virtual horizontal plane of the weight sensor, a storage unit configured to store reference outputs of the two axes of the accelerometer when the weight sensor is horizontal and at a reference position and temperature, and an arithmetic processing unit, where the level gauge includes a light emitting unit configured to make the inside luminescent, the arithmetic processing unit compares current outputs of the accelerometer of the weighing apparatus with the reference outputs, and detects an output change occurring in the x and/or y as a tilt of the weighing apparatus, and the light emitting unit is configured to be capable of switching between a first operation mode when the weighing apparatus is horizontal and a second operation mode when a tilt is detected.

### TECHNICAL FIELD

The present invention relates to a weighing apparatus capable of notifying a user of the necessity for a horizontal adjustment, and a weighing method using the same weighing apparatus.

### BACKGROUND ART

Patent Literature 1 discloses a weighing apparatus including a level gauge with a light that emits light with a light bulb as illustrated in FIG. 1, and this weighing apparatus can make a horizontal adjustment even at the time of installation in a dark place.

### CITATION LIST

### Patent Literature

Patent Literature 1: Japanese Published Examined Utility Model Application No. S54-32934

### SUMMARY OF INVENTION

### Technical Problem

The weighing apparatus disclosed in Patent Literature 1 is convenient in the point that a horizontal adjustment thereof is possible even in a dark place. However, the light of the conventional level gauge is insufficient as a means that alerts a user of the necessity for a horizontal adjustment of the weighing apparatus even though the light can make a bubble more visible, and there has been a problem that the user uses the weighing apparatus without making a horizontal adjustment and accurate weighing is not performed. Therefore, it is preferable that if the level gauge installed for the purpose of horizontal adjustments can make a user strongly recognize the necessity for a horizontal adjustment corresponding to a tilt level of the installed weighing apparatus, the user will be urged to make a horizontal adjustment.

In view of the above-described problem, the present invention provides a weighing apparatus capable of notifying a user of a horizontal state of a weighing apparatus detected independently of a level gauge, by a light emission mode of the level gauge caused by a light emitting unit, and a weighing method using the same weighing apparatus.

### Solution to Problem

A weighing apparatus includes a level gauge configured to indicate whether horizontal installation of the weighing apparatus is suitable, a weight sensor, a multi-axial accelerometer configured to detect acceleration changes of two axes of x, y by setting the x-axis and y-axis on a virtual horizontal plane of the weight sensor and setting a z-axis in a direction orthogonal to the virtual horizontal plane, a storage unit configured to store reference outputs of the two axes of the multi-axial accelerometer when the weight sensor is installed horizontally and at a reference position at a reference temperature, and an arithmetic processing unit, where the level gauge includes a light emitting unit configured to make the inside luminescent when turned on, the arithmetic processing unit compares current outputs of the two axes generated in the multi-axial accelerometer at an installation position of the weighing apparatus with the reference outputs, and detects an output change occurring in the x-axis and/or y-axis of the multi-axial accelerometer as a tilt occurring in the weighing apparatus, and the light emitting unit is configured be capable of switching between a first operation mode when the weighing apparatus is installed horizontally and a second operation mode when a tilt of the weighing apparatus is detected.

(Operation) When the light emitting unit operates in the first operation mode, the light emitting unit is maintained in a turned-off mode in the daytime or in a first turned-on mode at night, for example, with which the level gauge indicates that the weighing apparatus has been installed in a horizontal state, and when the light emitting unit operates in the second operation mode, the light emitting unit is turned on even in the daytime or changed into a second turned-on mode different from the first turned-on mode at night, for example, with which the level gauge indicates that the weighing apparatus has a tilt.

It is preferable that the arithmetic processing unit determines a tilt level of the weighing apparatus from the output change, and gradually changes a light emission mode in the second operation mode based on the tilt level.

(Operation) With a gradual change in the light emission mode of the level gauge based on the tilt level of the weighing apparatus, a user is notified of the tilt level of the installed weighing apparatus.

It is preferable that the arithmetic processing unit determines which of a plurality of successive numerical value ranges 1, 2 . . . n to determine a tilt level an output change Xh, Yh in the x-axis and/or y-axis of the multi-axial accelerometer falls within in the following equations (1) and (2), and the light emitting unit makes the level gauge emit light in a light emission mode that differs according to the numerical value range that the output change Xh, Yh falls within.

$$Xh = Xout ( θ ) - Xout ( 0 ) \qquad Equation ( 1 )$$

$$Yh = Yout ( θ ) - Yout ( 0 ) \qquad Equation ( 2 )$$

provided that
Xout (θ): x component to be output from the multi-axial accelerometer at an angle θ
Yout (θ): y component to be output from the multi-axial accelerometer at an angle θ
Xout (0): x component of reference output of the multi-axial accelerometer
Yout (0): y component of reference output of the multi-axial accelerometer

(Operation) A tilt level is determined from the output change Xh, Yh in the x-axis and/or y-axis of the multi-axial accelerometer calculated by the arithmetic processing unit, and the level gauge emits light in a light emission mode that differs for each tilt level.

It is preferable that the arithmetic processing unit changes a flashing speed of the light emitting unit in a stepwise manner according to a detected change of the tilt level in the second operation mode.

(Operation) A change in flashing speed of the level gauge caused by the light emitting unit indicates deterioration or improvement of the horizontal adjustment.

It is preferable that the arithmetic processing unit changes a turning-on intensity of the light emitting unit in a stepwise manner according to a detected change of the tilt level in the second operation mode.

(Operation) A change in turning-on intensity of the light emitting unit of the level gauge caused by the light emitting unit indicates deterioration or improvement of the horizontal adjustment.

It is preferable that the light emitting unit in the weighing apparatus is configured to be capable of making the level gauge emit light in a plurality of different colors, and the arithmetic processing unit makes the light emitting unit emit light in different colors in a stepwise manner according to a detected change of the tilt level in the second operation mode.

(Operation) A change in turning-on color of the level gauge caused by the light emitting unit indicates deterioration or improvement of the horizontal adjustment.

A weighing method using a weighing apparatus including a level gauge including a light emitting unit configured to make the inside luminescent when turned on, a weight sensor, a multi-axial accelerometer configured to detect acceleration changes of two axes of x, y by setting the x-axis and y-axis on a virtual horizontal plane of the weight sensor and setting a z-axis in a direction orthogonal to the virtual horizontal plane, a storage unit configured to store reference outputs of the two axes of the multi-axial accelerometer when the weight sensor is installed horizontally and at a reference position at a reference temperature, and an arithmetic processing unit, where the arithmetic processing unit executes a current output acquiring step in which current outputs on the two axes generated in the multi-axial accelerometer at an installation position of the weighing apparatus are acquired, an output change acquiring step in which the current outputs are compared with the reference outputs and an output change occurring in the x-axis and/or y-axis of the multi-axial accelerometer is acquired, a tilt detecting step in which whether the weighing apparatus has a tilt is detected based on the output change, and an installed state notifying step in which the light emitting unit is operated in either a first operation mode or a second operation mode based on whether a tilt has been detected.

(Operation) The level gauge illuminated by the light emitting unit operated in a first operation mode indicates that the weighing apparatus has been installed in a horizontal state, and the level gauge illuminated by the light emitting unit operated in a second operation mode different from the first operation mode indicates that the weighing apparatus has a tilt.

It is preferable that the arithmetic processing unit executes the installed state notifying step and operates the light emitting unit in the second operation mode, and executes a tilt level determining step in which a tilt level of the weighing apparatus is determined from the output change, and a tilt level notifying step in which the light emitting unit is made to emit light in a light emission mode that gradually changes according to an increase/decrease in the tilt level, the mode differing for each determined level of the tilt level.

(Operation) A gradual change in the light emission mode of the level gauge based on a tilt level of the weighing apparatus notifies a user of the tilt level of the installed weighing apparatus.

### Advantageous Effects of Invention

According to the weighing apparatus, a user is made to visually recognize a change from the first operation mode to the second operation mode occurring in the light emitting unit of the level gauge, for example, a change from a turned-off state to a turned-on state in the daytime, or a change in turning-on mode at night, and the user is alerted that the weighing apparatus has been installed in a tilting state when the light emitting unit is operating in the second operation mode, and accordingly, the necessity for a horizontal adjustment can be strongly impressed upon the user.

According to the weighing apparatus, a user who makes a horizontal adjustment can gradually recognize a tilt level change by visually recognizing, in addition to a position of a bubble of the level gauge, a change in light emission mode that occurs gradually, and therefore the user can easily recognize whether the installation of the weighing apparatus is coming closer to horizontality or is tilting further.

According to the weighing apparatus, a user who makes a horizontal adjustment can easily recognize that the tilt of the installed weighing apparatus has deteriorated or the tilt has been improved and the weighing apparatus has come closer to horizontality by visually recognizing, in addition to a position of a bubble of the level gauge, a stepwise change in flashing speed of the level gauge caused by the light emitting unit.

According to the weighing apparatus, a user who makes a horizontal adjustment can easily recognize that the tilt of the installed weighing apparatus has deteriorated or the tilt has been improved and the weighing apparatus has come closer to horizontality by visually recognizing, in addition to a position of a bubble of the level gauge, a stepwise change in turning-on intensity of the level gauge caused by the light emitting unit.

According to the weighing apparatus, a user who makes a horizontal adjustment can easily recognize that the tilt of the installed weighing apparatus has deteriorated or the tilt has been improved and the weighing apparatus has come closer to horizontality by visually recognizing, in addition to a position of a bubble of the level gauge, a change in light emission color of the level gauge caused by the light emitting unit.

### BRIEF DESCRIPTION OF DRAWINGS

FIG. 1 is a perspective view illustrating an external appearance of a weighing apparatus according to an embodiment of the present invention.

FIG. 2 is a plan view of the weighing apparatus of the present invention.

FIG. 2A is a longitudinal sectional view of the vicinity of a level gauge of the weighing apparatus of the present invention.

FIG. 3 is a block diagram relating to an overall configuration of the weighing apparatus of the present invention.

FIG. 4 is a flowchart related to Example 1 of a weighing method using the weighing apparatus of the present invention.

FIG. 5 is a flowchart related to Example 2 of a weighing method using the weighing apparatus of the present invention.

FIG. 6 is a flowchart related to Example 3 of a weighing method using the weighing apparatus of the present invention.

### DESCRIPTION OF EMBODIMENTS

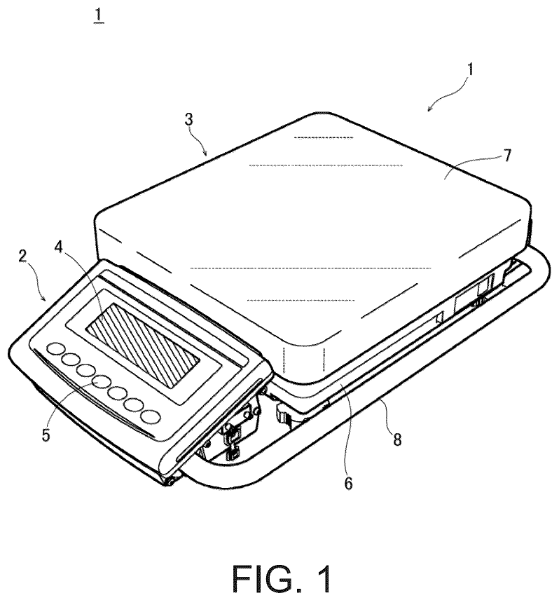

Next, a preferred embodiment of the present invention will be described with reference to FIGS. 1 to 3.

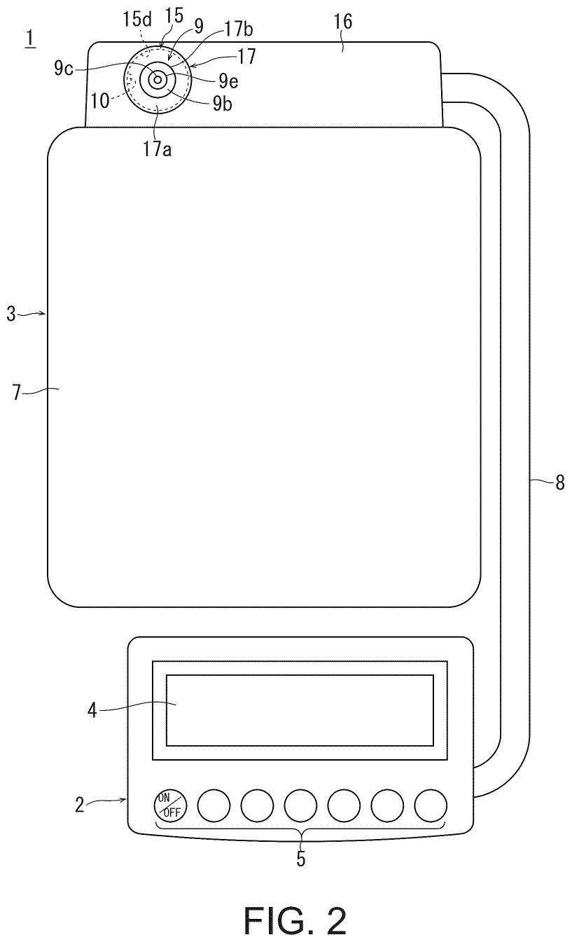

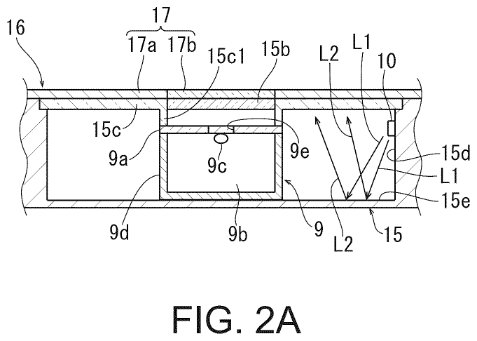

FIG. 1 is a perspective view illustrating an external appearance of a weighing apparatus 1 for carrying out a weighing method of the present invention, and FIG. 2 is a plan view of the weighing apparatus 1. The weighing apparatus 1 is configured with an operation and display unit 2, a main body unit 3, and a junction portion 8 joining these units.

As illustrated in FIGS. 1 and 2, the operation and display unit 2 includes a display unit 4 consisting of a liquid crystal screen or an organic EL screen, etc., and a plurality of operation buttons 5. The main body unit 3 includes a main body case 6, a weighing pan 7, and a level gauge 9. The display unit 4 displays a weighed value and a weighing result, etc., of a weighing object loaded on the weighing pan 7, and the plurality of operation buttons 5 of the weighing apparatus are used based on their respective roles for changing settings of the weighing apparatus 1 such as changing display contents on the display unit 4, changing a weighing mode of the weighing apparatus 1, and resetting a weighed value, etc. Inside the main body case 6, a weighing mechanism 13 described later, etc., are accommodated. The weighing pan 7 is provided in the weighing mechanism 13, and is loaded with a weighing object.

For the level gauge 9, a container 9d is filled with a liquid 9b in a state where one bubble 9c is formed inside the container, and is closed at an upper end opening by a transparent or semi-transparent top cover 9a on which an adjustment reference circle 9e is formed. Inside a case 16 at a rear end of the main body unit 3, an accommodation portion 15 that fixes the level gauge 9 is provided in an integral manner. The accommodation portion 15 is formed into a hollow columnar shape having an inner circumferential wall 15d and a bottom portion 15e, and is lidded from above by a light diffusion portion 15c. The light diffusion portion 15c is formed into a flange shape from acrylic resin or the like provided with frosting over an entire region except for a region of a transparent circular translucent portion 15b at a center, and integrally includes a cylindrical projection portion 15c1 projecting downward along an outer circumference of the translucent portion 15b. The level gauge 9 is fixed to a center of the bottom portion 15e inside the accommodation portion 15. The top cover 9a is installed in a state of contact with the entirety of the cylindrical projection portion 15c1 of the light diffusion portion 15c, while being spaced from the translucent portion 15b. Also, the accommodation portion 15 is covered from above by a circular sheet 17 that is slightly larger than an inner diameter of the inner circumferential wall 15d. The sheet 17 is formed of an opaque non-translucent portion 17a and a transparent translucent portion 17b formed at a center of the non-translucent portion 17a (the translucent portion 17b may be a circular through hole). The sheet 17 includes the translucent portion 17b disposed along an outer circumference of the translucent portion 15b, and is disposed so as to cover the light diffusion portion 15c by the non-translucent portion 17a.

The bubble 9c and the adjustment reference circle 9e of the level gauge 9 are exposed to the outside through the translucent portion 15b and the translucent portion 17b. The bubble 9c is positioned at a center of the adjustment reference circle 9e of the level gauge 9 when the weighing apparatus 1 is installed horizontally. On the inner circumferential wall 15d of the accommodation portion 15, an LED 10 as a light emitting unit configured to emit light toward the light diffusion portion 15c is disposed. On the bottom portion 15e inside the accommodation portion 15, a large number of fine bumps and dips are formed. Irradiation light L1 by the LED 10 is applied toward the bottom portion 15e having bumps and dips, and irregularly reflected inside the accommodation portion 15c. Further, the irregularly reflected light L2 is diffused inside the frosted light diffusion portion 15c toward the translucent portion 15b and is shielded from above by the non-translucent portion 17a of the sheet 17, and accordingly, the light is entirely applied to the level gauge 9 and brightly illuminates the bubble 9c and the adjustment reference circle 9e. The light emitted by the LED 10 is irregularly reflected by the bumps and dips of the bottom portion 15e inside the accommodation portion 15, and illuminates the inside of the level gauge 9 by diffused light made by further being transmitted through the light diffusion portion 15c, so that a problem in which a line of light is generated inside the level gauge 9 and causes difficulty in viewing the bubble 9c and the adjustment reference circle 9e does not occur. The LED 10 is preferably formed to be capable of switching a light emission color by being provided with a multi-color light emitting unit, however, the light emission color may be a single color. The light emitting unit of the level gauge 9 is not limited to the LED 10, and may use a light emitting device light source such as a laser diode or a bulb as long as the light emitting unit of the level gauge 9 is configured to be capable of emitting light in a single color or multiple colors.

Next, with reference to FIGS. 1 to 3, a detailed overall configuration of the weighing apparatus 1 of the present invention will be described. The operation and display unit 2 includes, in addition to the display unit 4 and the operation buttons 5 installed so as to be exposed to the outside, an arithmetic processing unit 11 and a storage unit 12 inside. The arithmetic processing unit 11 consists of an arithmetic control device such as a CPU. The display unit 4, the operation buttons 5, and the storage unit 12 are respectively connected to the arithmetic processing unit 11 and controlled by the arithmetic processing unit 11.

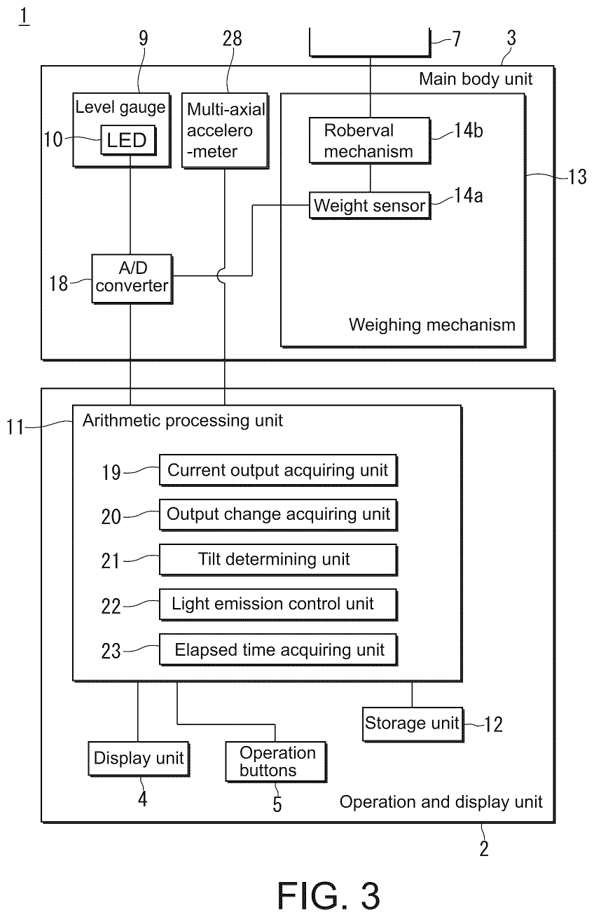

As illustrated in FIG. 3, the main body unit 3 includes the level gauge 9, and a weighing mechanism 13 inside. The weighing mechanism 13 is an electromagnetic weighing mechanism, and includes a weight sensor 14a, a Roberval mechanism 14b, an A/D converter 18, and a multi-axial accelerometer 28.

As illustrated in FIG. 3, the weighing pan 7 is provided in the Roberval mechanism 14b, and the Roberval mechanism 14b is connected to the weight sensor 14a. The Roberval mechanism 14b is a mechanism that transmits a load of a weighing object applied onto the weighing pan 7 to the weight sensor 14a. The weight sensor 14a is connected to the arithmetic processing unit 11 via the A/D converter 18, and is controlled by the arithmetic processing unit 11.

The multi-axial accelerometer 28 illustrated in FIG. 3 consists of a capacitance type biaxial accelerometer or triaxial accelerometer such as an MEMS (Micro Electro Mechanical System) sensor that generates a voltage change according to changes in installation direction, installation height, and environmental temperature of an installation location, and is connected to the arithmetic processing unit 11. The multi-axial accelerometer 28 fixed to the weighing apparatus 1 detects output values of gravitational accelerations and tilt angles of two axes of x, y from voltage value changes occurring when the weighing apparatus is installed at a measurement site from a reference position.

As illustrated in FIG. 3, the operation and display unit 2 includes the arithmetic processing unit 11 and the storage unit 12 inside. The arithmetic processing unit 11 is an arithmetic processing device such as a CPU, and includes a current output acquiring unit 19, an output change acquiring unit 20, a tilt determining unit 21, a light emission control unit 22, and an elapsed time acquiring unit 23. The display unit 4 and the operation buttons 5 are respectively connected to the arithmetic processing unit 11, and display contents and display/hiding of the display contents of the display unit 4 are controlled by the arithmetic processing unit 11. Turning-on/off and light emission color selection of the LED 10 of the level gauge 9 are controlled by the light emission control unit 22 of the arithmetic processing unit 11.

In the storage unit 12, Xout (0) and Yout (0) as output values of angles of the x-axis and y-axis of the incorporated multi-axial accelerometer 28 when the weighing apparatus 1 is installed horizontally are stored in advance as reference outputs.

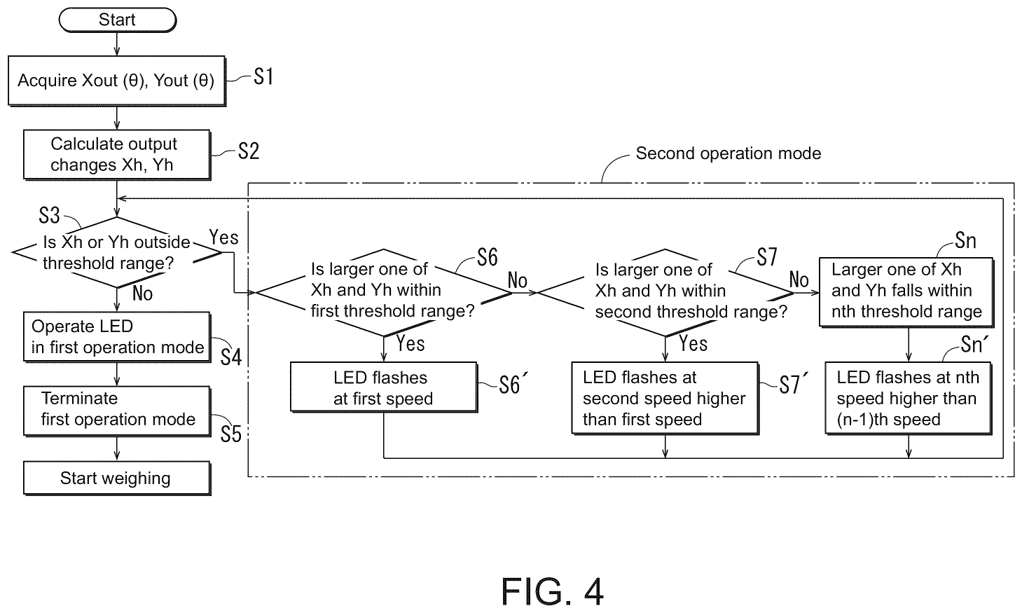

Next, Example 1 of a tilt detecting method using the weighing apparatus according to the present embodiment will be described with reference to FIG. 4. When a user installs the weighing apparatus 1 at a measurement site and plugs an AC adapter (not illustrated) into an outlet, the arithmetic processing unit 11 of the weighing apparatus 1 executes a current output acquiring step S1 by the current output acquiring unit 19, and acquires current outputs: Xout (θ) and Yout (θ) related to angles of the x-axis and y-axis of the multi-axial accelerometer 28 measured at the measurement site.

Next, the arithmetic processing unit 11 executes an output change acquiring step S2 by the output change acquiring unit 20, and calculates an output change Xh, Yh occurring in the x-axis and/or y-axis of the multi-axial accelerometer 28 from the current outputs acquired at the installation location and reference outputs at the time of horizontal installation read from the storage unit 12 by using the following equations (1) and (2).

$$Xh = Xout ( θ ) - Xout ( 0 ) \qquad Equation ( 1 )$$

$$Yh = Yout ( θ ) - Yout ( 0 ) \qquad Equation ( 2 )$$

Subsequently, the arithmetic processing unit 11 executes a tilt detecting step S3 by the tilt detecting unit 21, and detects whether Xh and/or Yh of the installed weighing apparatus 1 is at a numerical value within a predetermined threshold range approximating 0 from which the weighing apparatus 1 can be determined to have been installed horizontally. Specifically, when 0≤Xh≤a0 and 0≤Yh≤a0 (a0 is a limit value from which horizontality can be determined) are reached, the tilt determining unit 21 determines that the weighing apparatus has been installed horizontally based on Xh and Yh being both at numerical values within the threshold range, and when Xh>a0 or Yh>a0 is reached, the tilt determining unit 21 determines that the weighing apparatus has been installed in a tilting state based on either Xh or Yh being at a numerical value outside the threshold range.

When horizontal installation of the weighing apparatus 1 is detected based on Xh and Yh being both at numerical values within the threshold range, the arithmetic processing unit 11 executes a horizontality notifying step S4 as an installed state notifying step by the light emission control unit 22, and operates the LED 10 in a first operation mode. Specifically, by maintaining the LED 10 in a turned-off mode or turning the LED 10 on, the arithmetic processing unit 11 notifies a user that it is unnecessary to make a horizontal adjustment of the installed weighing apparatus 1. The arithmetic processing unit 11 acquires an elapsed time of the first operation mode by the elapsed time acquiring unit 23, and terminates the first operation mode of the LED 10 by executing a horizontality notification terminating step S5 by the light emission control unit 22 after the elapse of a predetermined time (for example, after 10 seconds elapse from the start of the first operation mode) in which the user is believed to have sufficiently confirmed the horizontal installation of the weighing apparatus 1. At this time, the light emission control unit 22 turns the LED 10 off when the first operation mode is a turned-on state. Then, the arithmetic processing unit 11 shifts the weighing apparatus into a weighable state, and weighing by the user is performed.

On the other hand, when the arithmetic processing unit 11 detects installation of the weighing apparatus 1 in a tilting state based on Xh or Yh being at a numerical value outside the threshold range in the tilt detecting step S3, the arithmetic processing unit 11 operates the LED 10 in the second operation mode by the light emission control unit 22 based on further tilt determination results by the tilt determining unit 21.

Specifically, the arithmetic processing unit 11 executes tilt level determining steps S6, S7. . . . Sn as part of the installed state notifying step in order by the tilt detecting unit 21, and determines which of a first threshold range to an nth threshold range either larger numerical value of the numerical values of Xh and Yh falls within. Here, the ranges from a first threshold to an nth threshold are ranges obtained by equally dividing a range from a limit value a0 from which horizontality can be determined to a limit value an from which a tilt is detectable by n, and are the first threshold range being set as a0<Xh≤a1 or a0<Yh≤a1, the second threshold range being set as a1<Xh≤a2 or a1<Yh≤a2, . . . the nth threshold range being set as a (n-1)<Xh≤an or a (n-1)<Yh≤an. Tilt levels of the installed weighing apparatus 1 are set as a first tilt level, a second tilt level . . . an nth tilt level by respectively corresponding to the first threshold, the second threshold . . . the nth threshold. A tilt of the installed weighing apparatus 1 becomes minimum at the first tilt level, and the tilt increases as the tilt level number becomes larger, and becomes maximum at the nth tilt level.

When the tilt determining unit 21 determines that either larger numerical value of Xh or Yh falls within the first threshold range and is the first tilt level in the tilt level determining step S6, the arithmetic processing unit 11 executes a tilt level notifying step S6′ by the light emission control unit 22, and makes the LED 10 flash at a first speed. On the other hand, when the tilt determining unit 21 determines that either larger numerical value of Xh or Yh is outside the first threshold range, the arithmetic processing unit 11 makes the tilt determining unit 21 execute the tilt level determining step S7. When the tilt determining unit 21 determines that either larger numerical value of Xh or Yh falls within the second threshold range and is the second tilt level in Step S7, the arithmetic processing unit 11 executes a tilt level notifying step S7′ by the light emission control unit 22, and makes the LED 10 flash at a second speed higher than the first speed. On the other hand, when the tilt determining unit 21 determines that either larger numerical value of Xh or Yh is outside the second threshold range, the arithmetic processing unit 11 executes a step of determining whether the value falls within the next threshold range by the tilt determining unit 21. By executing the tilt level determining steps S6 to Sn in order in this way, the tilt determining unit 21 of the arithmetic processing unit 11 judges which of the first to nth threshold ranges either larger numerical value of Xh or Yh falls within to determine a tilt level, and the light emission control unit 22 makes the LED 10 flash at a speed corresponding to the tilt level by executing a corresponding tilt level notifying step. When either larger numerical value of Xh or Yh reaches the nth tilt level that is the maximum tilt level of the weighing apparatus 1 (the tilt level determining step Sn), the arithmetic processing unit 11 executes a step Sn′ by the light emission control unit 22, and makes the LED 10 flash at a highest nth speed.

In Example 1, a flashing speed of the level gauge 9 that is illuminated by the LED 10 increases as the tilt level goes higher, and the flashing speed increases, in such a manner as the first speed (lowest)<the second speed (slightly higher than the first speed)< . . . <the n-1th speed (slightly lower than the nth speed)<the nth speed (highest), as the tilt of the installed weighing apparatus 1 increases.

The user visually recognizes a flashing speed of the level gauge 9 caused by the LED 10, and is made strongly aware that the tilt of the weighing apparatus 1 increases as the flashing speed increases, and accordingly, the user is urged to make a horizontal adjustment. The arithmetic processing unit 11 of the weighing apparatus 1 executes any of the tilt level notifying steps S6′, S7′ . . . . Sn′ by the light emission control unit 22, and then repeatedly executes Step S3 by the tilt level determining unit based on a horizontal adjustment made by the user, and as long as a tilt is determined, the arithmetic processing unit 11 repeatedly makes determinations of the tilt determining steps S6 to Sn and flashing of the LED 10 at any of the speeds of the tilt level notifying steps S6′ to Sn′. The flashing speed of the LED 10 gradually changes based on deterioration or improvement of the horizontal adjustment made by the user, so that the user can recognize that the horizontal adjustment has deteriorated further based on an increase in flashing speed of the LED 10, and that the horizontal adjustment has been improved and the apparatus has come closer to horizontality based on a decrease in flashing speed.

When the tilt determining unit 21 of the arithmetic processing unit 11 detects that both of Xh and Yh are both at numerical values within the threshold range due to a horizontal adjustment made by the user, the tilt determining unit 21 determines that the weighing apparatus 1 has been reinstalled horizontally, and executes the horizontality notifying step S4 by the light emission control unit 22 and operates the LED 10 in the first operation mode. At this time, the LED 10 shifts from the flashing state to a turned-off state or a turned-on state, and notifies the user that the horizontal adjustment of the installed weighing apparatus 1 has been completed. After a predetermined time elapses, the arithmetic processing unit 11 terminates the first operation mode of the LED 10 by executing the horizontality notification terminating step S5 by the light emission control unit 22, and shifts the weighing apparatus into a weighable state, and accordingly, weighing by the user is performed.

In Example 1, the necessity for a horizontal adjustment is indicated to a user by a flashing speed of the level gauge 9 just after the power supply is turned on. The user is made more strongly aware that the weighing apparatus 11 has been installed on a tilt as the flashing speed of the level gauge 9 increases, and accordingly, the user is urged to make a horizontal adjustment. In the weighing apparatus 1, in the second operation mode of the LED 10, it is also possible that as the tilt level goes higher from the first tilt level to the nth tilt level, the corresponding LED flashing speed is decreased. In this case, based on a stepwise increase in flashing speed of the LED according to a decrease in tilt level, the user can be made to recognize that the horizontal adjustment is coming to an end.

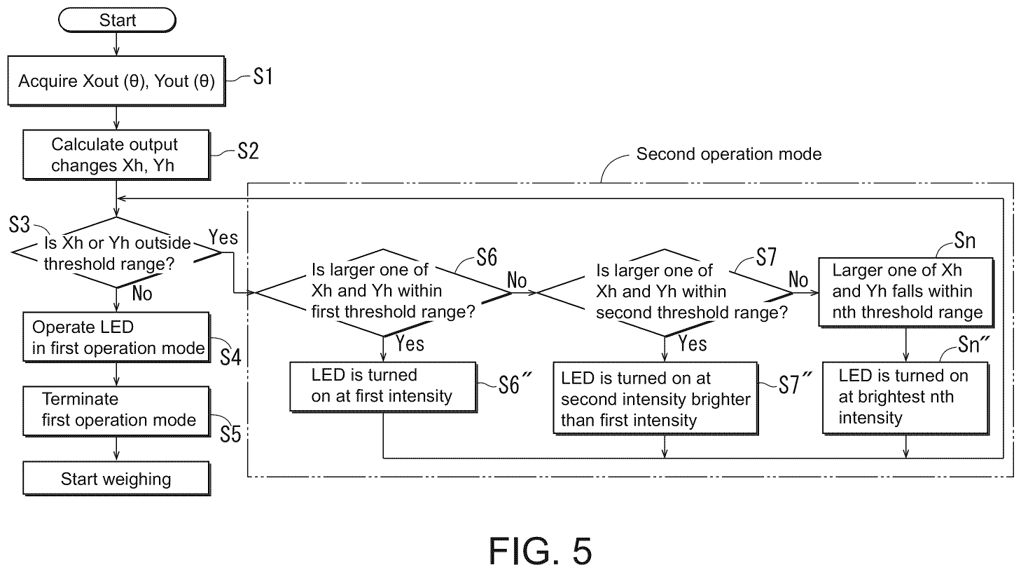

Next, with reference to FIG. 5, Example 2 of a tilt detecting method using the weighing apparatus according to the present embodiment will be described. In the tilt detecting method of Example 2, except that the first operation mode of the LED 10 in the horizontality notifying step S4 and turning-on/off modes of the LED 10 in tilt level notifying steps S6″, S7″ . . . . Sn″ in the second operation mode are different, means common to Example 1 is carried out. In the horizontality notifying step S4 of Example 2, the LED 10 that operates in the first operation mode is maintained in a turned-off state or a flashing state. In the second operation mode of the LED 10 in Example 1, by increasing the flashing speed of the LED 10 as a tilt level of the weighing apparatus 1 determined from either larger numerical value of Xh or Yh goes higher, improvement or deterioration of the tilt level is notified to a user, however, in the second operation mode of Example 2, as the tilt level goes higher, the light emission intensity of the LED 10 is increased in a stepwise manner.

In Example 2, the following processing is performed specifically in the second operation mode. First, the arithmetic processing unit 11 executes the tilt level determining steps S6, S7. . . . Sn in order by the tilt determining unit 21, and determines which of the first threshold range to the nth threshold range either larger numerical value of the numerical values of Xh and Yh falls within. The first threshold range to the nth threshold range and the corresponding first tilt level to nth tilt level are the same as in Example 1. When the tilt level determining unit 21 determines that either larger numerical value of Xh or Yh falls within the first threshold range and is the first tilt level in the tilt level determining step S6, the arithmetic processing unit 11 executes the tilt level notifying step S6″ by the light emission control unit 22, and turns the LED 10 on at a first intensity. On the other hand, when the tilt determining unit 21 determines that either larger numerical value of Xh or Yh is outside the first threshold range, the arithmetic processing unit 11 makes the tilt determining unit 21 execute the tilt level determining step S7. When it is determined that either larger numerical value of Xh or Yh falls within the second threshold range and is the second tilt level, the arithmetic processing unit 11 makes the light emission control unit 22 execute the tilt level notifying step S7″, and turns the LED 10 on at a second intensity higher than the first intensity.

On the other hand, when the tilt determining unit 21 determines that either larger numerical value of Xh or Yh is outside the second threshold range, the arithmetic processing unit 11 executes a tilt level determining step of determining whether the value falls within the next threshold range by the tilt level determining unit 21. In this way, by executing the tilt level determining steps S6 to Sn in order, the tilt determining unit 21 of the arithmetic processing unit 11 determines a tilt level of the installed weighing apparatus 1 from either larger numerical value of Xh or Yh, and the light emission control unit 22 turns the LED 10 on with a brightness corresponding to the tilt level by executing a tilt level notifying step corresponding to the tilt level. When either larger numerical value of Xh or Yh reaches the nth tilt level that is the maximum tilt level of the weighing apparatus 1 (Step Sn), the arithmetic processing unit 11 executes the tilt level notifying step Sn″ by the light emission control unit 22 and turns the LED 10 on at the highest nth intensity.

In Example 2, the LED 10 is turned on with a brightness that increases, in such a manner as a first intensity (darkest although turned on)<a second intensity (slightly brighter than the first intensity)< . . . <an n-1th intensity (slightly darker than an nth intensity)<the nth intensity (brightest), as the tilt of the installed weighing apparatus 1 increases. A user visually recognizes the brightness of the level gauge 9 illuminated by the LED 10, and makes a horizontal adjustment by being made strongly aware that the more brightly the level gauge is illuminated, the larger the tilt of the weighing apparatus 1 is. After executing any of Steps S6″, S7″ . . . . Sn″ by the light emission control unit 22, the arithmetic processing unit 11 of the weighing apparatus 1 repeatedly executes the tilt detecting step S3 by the tilt determining unit 21 in association with a horizontal adjustment made by the user, and as long as a tilt is determined, repeats determinations of the tilt level determining steps S6 to Sn and turning-on of the LED 10 according to an intensity (brightness) of any of the tilt level notifying steps S6″ to Sn″. The brightness of the LED 10 gradually changes based on deterioration or improvement of the horizontal adjustment made by the user, so that the user can recognize that the horizontal adjustment has deteriorated more as the irradiation intensity of the LED 10 increases and the LED becomes brighter, and that the horizontal adjustment has been improved and the apparatus has come closer to horizontality as the irradiation intensity decreases and the LED becomes darker.

When the tilt determining unit 21 of the arithmetic processing unit 11 detects that both of Xh and Yh are at numerical values within the threshold range due to the horizontal adjustment made by the user, the tilt determining unit 21 determines that the weighing apparatus 1 has been reinstalled horizontally, and executes the horizontality notifying step S4 by the light emission control unit 22 and operates the LED 10 in the first operation mode. At this time, the light emission control unit 22 shifts the LED 10 into a turned-off state or a flashing state by executing the horizontality notification terminating step S5, and notifies the user that the horizontal adjustment of the installed weighing apparatus 1 has been completed. After a predetermined time elapses, the arithmetic processing unit 11 terminates the first operation mode of the LED 10 by executing the horizontality notification terminating step S5 by the light emission control unit 22, and shifts the weighing apparatus into a weighable state, and accordingly, weighing by the user is performed.

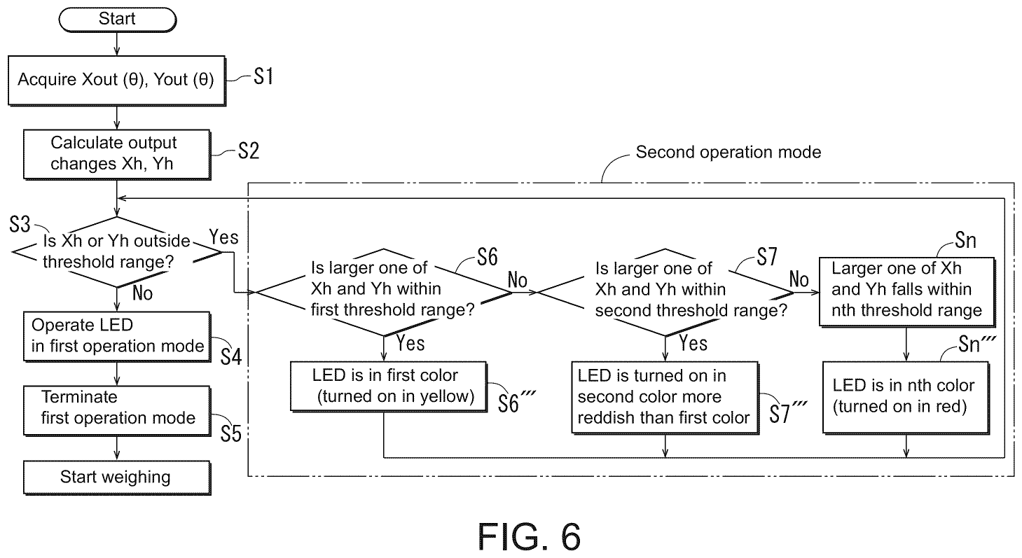

Next, Example 3 of a tilt detecting method using the weighing apparatus according to the present embodiment will be described with reference to FIG. 6. In the tilt detecting method of Example 3, except that the first operation mode of the LED 10 in the horizontality notifying step S4 and turning-on/off modes of the LED 10 in tilt level notifying steps S6′″, S7′″, . . . . Sn′″ are different, means common to Example 1 is carried out. The LED 10 that operates in the first operation mode in the horizontality notifying step S4 of Example 3 is configured to be capable of being turned on in multiple colors, and is maintained turned-on in green as an example. In a second operation mode of Example 3, at the first tilt level that is the smallest, the LED 10 is turned on in yellow (first color), and as the tilt level increases, the LED 10 is turned on in orange made by adding a large amount of red to yellow (a second color to an n-1th color), and at the nth tilt level that is the largest, the LED 10 is turned on in red (an nth color).

In Example 3, the following processing is performed specifically in the second operation mode. First, the arithmetic processing unit 11 executes the tilt level determining steps S6, S7. . . . Sn in order by the tilt determining unit 21, and determines which of the first threshold range to the nth threshold range either larger numerical value of the numerical values of Xh and Yh falls within. The first threshold range to the nth threshold range and the corresponding first tilt level to nth tilt level are the same as in Example 1. In the tilt level determining step S6, when the tilt determining unit 21 determines that either larger numerical value of Xh or Yh falls within the first threshold range and determines the first tilt level, the arithmetic processing unit 11 executes the tilt level notifying step S6″′ by the light emission control unit 22, and turns the LED 10 on in yellow (first color). On the other hand, when the tilt determining unit 21 determines that either larger numerical value of Xh or Yh is outside the first threshold range, the arithmetic processing unit 11 executes the tilt level determining step S7 by the tilt determining unit 21. When it is determined that either larger numerical value of Xh or Yh falls within the second threshold range and is the second tilt level, the arithmetic processing unit 11 executes the tilt level notifying step S7″′ by the light emission control unit 22, and turns the LED 10 on in orange (second color) made by slightly adding red to yellow.

On the other hand, when the tilt determining unit 21 determines that either larger numerical value of Xh or Yh is outside the second threshold range, the arithmetic processing unit 11 executes a tilt level determining step of determining whether the value falls within the next threshold range by the tilt determining unit 21. The tilt determining unit 21 of the arithmetic processing unit 11 determines a tilt level of the installed weighing apparatus 1 from either larger numerical value of Xh or Yh by executing the tilt level determining steps S6 to Sn in order, and makes the LED 10 emit light in a color (from the first color to the nth color) corresponding to the tilt level (from the first tilt level to the nth tilt level). Specifically, as the tilt level goes higher, the light emission control unit 22 of the arithmetic processing unit 11 controls the LED 10 so as to emit light in orange that is gradually made to be more reddish (from a second tilt level to an n-1th tilt level) from yellow (first tilt level) each time the tilt level rises by 1. Then, when either larger numerical value of Xh or Yh reaches the nth tilt level that is the maximum tilt level of the weighing apparatus 1 (Step Sn), the light emission control unit 22 of the arithmetic processing unit 11 executes the tilt level notifying step Sn″ and turns the LED 10 on in red (the nth tilt level).

In Example 3, the LED 10 is turned on in a color that changes from yellow to reddish orange as the tilt of the installed weighing apparatus 1 increases, and is turned on in red at the time of a maximum tilt, where the color changes, in such a manner as a first color (yellow)<a second color (orange made by slightly adding red to yellow)<a third color (orange a little more reddish than the second color) . . .<an n-1th color (orange a little less reddish than red)<an nth color (red). A user visually recognizes that a light emission color of the level gauge 9 illuminated by the LED 10 becomes more reddish from yellow in a stepwise manner according to an increase in tilt level and changes from orange to red, and is urged to make a horizontal adjustment by being made strongly aware that the tilt of the weighing apparatus 1 becomes larger as the reddishness of orange increases. After executing any of the tilt level notifying steps S6″′, S7″′ . . . . Sn″′ by the light emission control unit 22, the arithmetic processing unit 11 of the weighing apparatus 1 repeatedly executes the tilt detecting step S3 by the tilt determining unit 21 in association with a horizontal adjustment made by the user, and as long as a tilt is determined, repeats determinations of the tilt level determining steps S6 to Sn and turning-on of the LED 10 in any of colors of the tilt level notifying steps S6″′ to Sn″. The light emission color of the LED 10 gradually changes based on deterioration or improvement of the horizontal adjustment made by the user, so that the user can recognize that the horizontal adjustment has deteriorated more as the light emission color of the LED 10 gets closer to red from orange, and that the horizontal adjustment has been improved and the apparatus has come closer to horizontality as the light emission color of the LED 10 gets closer to yellow from orange.

When the tilt determining unit 21 of the arithmetic processing unit 11 detects that both of Xh and Yh are at numerical values within the threshold range due to the horizontal adjustment made by the user, the tilt determining unit 21 determines that the weighing apparatus 1 has been reinstalled horizontally, and executes the horizontality notifying step S4 by the light emission control unit 22 and operates the LED 10 in the first operation mode. At this time, the light emission control unit 22 notifies the user that the horizontal adjustment of the installed weighing apparatus 1 has been completed by changing the light emission color into a turned-on state of the LED 10 in green from yellow. After a predetermined time elapses, the arithmetic processing unit 11 terminates the first operation mode (turns off the green light emission) of the LED 10 by executing the horizontality notification terminating step S5 by the light emission control unit 22, and shifts the weighing apparatus into a weighable state, and accordingly, weighing by the user is performed.

In Example 3, three or more colors are provided as the light emission color of the LED 10 so that the light emission color is green in the first operation mode, and the light emission color in the second operation mode is orange that gradually changes from yellow to red, however, a simple mode may be applied in which the light emission colors of the LED 10 are three colors in total including one green color in the first operation mode and two yellow and red colors in the second operation mode, and in the second operation mode, the LED 10 emits light in red when the tilt is large, and emits light in yellow when the tilt is small. The light emission colors of the LED 10 are not limited to green, yellow, and red, and may be a combination of a large variety of colors.

### REFERENCE SIGNS LIST

1 Weighing apparatus
7 Weighing pan
11 Arithmetic processing unit
12 Storage unit
28 Multi-axial accelerometer
S1 Current output acquiring step
S2 Output change acquiring step
S3 Tilt detecting step
S4 Horizontality notifying step as an installed state notifying step
S6 to Sn Tilt level determining step
S6″ to S7″ Tilt level notifying step
S6″′ to S7′″ Tilt level notifying step
Xout (0), Yout (0) Reference output
Xout (θ), Yout (θ) Current output

1. A weighing apparatus comprising:
a level gauge configured to indicate whether horizontal installation of the weighing apparatus is suitable;
a weight sensor;
a multi-axial accelerometer configured to detect acceleration changes of two axes of x, y by setting the x-axis and y-axis on a virtual horizontal plane of the weight sensor and setting a z-axis in a direction orthogonal to the virtual horizontal plane;
a storage unit configured to store reference outputs of the two axes of the multi-axial accelerometer when the weight sensor is installed horizontally and at a reference position at a reference temperature; and
an arithmetic processing unit, wherein
the level gauge includes
a light emitting unit configured to make the inside luminescent when turned on,
the arithmetic processing unit
compares current outputs of the two axes generated in the multi-axial accelerometer at an installation position of the weighing apparatus with the reference outputs, and detects an output change occurring in the x-axis and/or y-axis y of the multi-axial accelerometer as a tilt occurring in the weighing apparatus, and
the light emitting unit is configured to be capable of switching between a first operation mode when the weighing apparatus is installed horizontally and a second operation mode when a tilt of the weighing apparatus is detected.

2. The weighing apparatus according to claim 1, wherein the arithmetic processing unit
determines a tilt level of the weighing apparatus from the output change, and
gradually changes a light emission mode in the second operation mode based on the tilt level.

3. The weighing apparatus according to claim 2, wherein
the arithmetic processing unit determines which of a plurality of successive numerical value ranges 1, 2 . . . n to determine a tilt level an output change Xh, Yh in the x-axis and/or y-axis of the multi-axial accelerometer falls within in the following equations (1) and (2), and
the light emitting unit makes the level gauge emit light in a light emission mode that differs according to the numerical value range that the output change Xh, Yh falls within.
$$Xh = Xout ( θ ) - Xout ( 0 ) \qquad Equation ( 1 )$$
$$Yh = Yout ( θ ) - Yout ( 0 ) \qquad Equation ( 2 )$$
provided that
Xout (θ): x component to be output from the multi-axial accelerometer at an angle θ
Yout (θ): y component to be output from the multi-axial accelerometer at an angle θ
Xout (0): x component of a reference output of the multi-axial accelerometer
Yout (0): y component of a reference output of the multi-axial accelerometer

4. The weighing apparatus according to claim 2, wherein the arithmetic processing unit changes a flashing speed of the light emitting unit in a stepwise manner according to a detected change of the tilt level in the second operation mode.

5. The weighing apparatus according to claim 2, wherein the arithmetic processing unit changes a turning-on intensity of the light emitting unit in a stepwise manner according to a detected change of the tilt level in the second operation mode.

6. The weighing apparatus according to claim 2, wherein
the light emitting unit is configured to be capable of making the level gauge emit light in a plurality of different colors, and
the arithmetic processing unit makes the light emitting unit emit light in different colors in a stepwise manner according to a detected change of the tilt level in the second operation mode.

7. A weighing method using
a weighing apparatus including a level gauge including a light emitting unit configured to make the inside luminescent when turned on, a weight sensor, a multi-axial accelerometer configured to detect acceleration changes of two axes of x, y by setting the x-axis and y-axis on a virtual horizontal plane of the weight sensor and setting a z-axis in a direction orthogonal to the virtual horizontal plane, a storage unit configured to store reference outputs of the two axes of the multi-axial accelerometer when the weight sensor is installed horizontally and at a reference position at a reference temperature, and an arithmetic processing unit, wherein
the arithmetic processing unit executes:
a current output acquiring step in which current outputs on the two axes generated in the multi-axial accelerometer at an installation position of the weighing apparatus are acquired;
an output change acquiring step in which the current outputs are compared with the reference outputs and an output change occurring in the x-axis and/or y-axis of the multi-axial accelerometer is acquired;
a tilt detecting step in which whether the weighing apparatus has a tilt is detected based on the output change; and
an installed state notifying step in which the light emitting unit is operated in either a first operation mode or a second operation mode based on whether a tilt has been detected.

8. The weighing method according to claim 7, wherein
the arithmetic processing unit executes the installed state notifying step and operates the light emitting unit in the second operation mode, and executes:
a tilt level determining step in which a tilt level of the weighing apparatus is determined from the output change; and
a tilt level notifying step in which the light emitting unit is made to emit light in a light emission mode that gradually changes according to an increase/decrease in the tilt level, the mode differing for each detected level of the tilt level.
